(19) United States
(12) Patent Application Publication
(10) Pub. No.: US 2011/0313895 A1
(43) Pub. Date: Dec. 22, 2011

(54) METHOD FOR REFERRAL-BASED FINANCIAL TRANSACTION PROCESSING

(76) Inventors: Danny K. Choi, Costa Mesa, CA (US); Melinda A. Choi, Costa Mesa, CA (US)

(21) Appl. No.: 12/817,040

(22) Filed: Jun. 16, 2010

(51) Int. Cl. G06Q 40/00

(52) U.S. Cl. 705/30; 705/39

(57) ABSTRACT

A method for discounting costs of credit card processing for merchant participants is disclosed. A first account is associated with a first one of the merchant participants, and a unique referral identifier may be assigned thereto. A request to process one or more credit card transactions on behalf of the second one of the merchant participants is transmitted along with the referral identifier. The credit card transactions have a cost differential, from which a first fee reimbursement value is derived. The first account is credited based upon the first fee reimbursement value.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to processing financial transactions, and more particularly, to a method for distributing the costs associated with credit card transactions based upon participant referrals.

2. Related Art

Payment for goods and services is completed either by exchanging currency, or by provisioning, which involves the transfer of money from one account to another. This includes credit cards, debit cards, charge cards, personal checks, and the like. Such payment types offer different conveniences to the user. For example, credit cards may have flexible payment options with the option of maintaining a balance (subject to interest). Debit cards and checks may immediately deduct funds from an account upon payment. A charge card may be similar to credit cards in that credit is temporarily extended to the user, except that any balance must be paid off monthly. However, common characteristic of all such payment types is the elimination of an immediate and direct exchange of cash.

With credit cards as a particular example, the payer/customer in a transaction presents the payee/merchant with the card, which is associated with an issuing bank. The card bears a unique number that is tied to an account with the issuing bank held by the payer/customer. In addition to the card number, the card bears an expiration date and a security code, if there is one. The payee/merchant then seeks authorization from the issuing bank to verify that the payer/customer has sufficient funds or credit to complete the transaction. The request for authorization is typically made over high-speed telecommunications links that are part of a credit card processing network using a credit card payment terminal or point of sale system. Popular credit card processing association networks include VISA®, MASTERCARD®, DISCOVER®, among many others. The payee/merchant normally receives an authorization response in real-time, and can complete the transaction in a relatively short period of time. The respective accounts are not debited and credited immediately, but at predetermined intervals, the transactions, which are stored as batches, are submitted to the credit card processing network. Once the batches are settled, the payee/merchant's bank account is credited. The payer/customer's credit card account with the issuing bank is debited, and the exchange of funds is complete.

As briefly mentioned above, one significant benefit of credit cards and other forms of cashless payment is convenience, and an increasing number of account holders are using such payment methods for all but the smallest of transactions. Merchants similarly benefit, as a lesser volume of cash on the business premises reduces the likelihood of theft and robbery. However, with each transaction, there are a number of associated fees charged by the credit card networks. The merchant is usually charged a commission of 1% to 3% of the value of the transaction as processing fees, as well as a variable interchange rate payable to the credit card association network. For low-margin transactions, the merchant may end up losing more money than the transaction not having occurred at all. In order to avoid this, merchants have resorted to establishing transaction minimums, even though the agreements with the issuing banks may restrict such practices. Some merchants have stopped accepting credit cards altogether.

Therefore, there exists a need for an improved financial transaction processing methods, particularly those that distribute the costs of using a credit card processing network.

### BRIEF SUMMARY

In accordance with one embodiment of the present disclosure, there is contemplated a method for issuing credits for credit card processing for merchant participants. The method may include associating a first account with a first one of the merchant participants. A unique referral identifier may be assigned to the first account, and may be distributable to a second one of the merchant participants. The method may also include transmitting a request to process one or more credit card transactions on behalf of the second one of the merchant participants. The destination of this request may be a credit card processor. Each of the credit card transactions may have a cost differential associated therewith. The credit card transactions may also include the unique referral identifier that is assigned to the first account. There may also be a step of deriving a first fee reimbursement value from the credit card transactions processed on behalf of the second one of the merchant participants within a cycle. Additionally, the method may include crediting the first account based upon the first fee reimbursement value. The cost differentials may be payable by the second one of the merchant participants. The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating an exemplary environment in which one embodiment of the present disclosure may be implemented;

FIG. 2 is a block diagram illustrating a program for crediting merchants in accordance with one embodiment of the present disclosure;

FIG. 3 is a flowchart of one embodiment of a method for issuing credits for costs of credit card processing;

FIG. 4 is a block diagram of an exemplary server computer system on which various embodiments of the present disclosure may be implemented;

FIG. 5A is an example first embodiment of a statement generated by the program for crediting merchants; and

FIG. 5B is an example third embodiment of the statement generated by the program.

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

A method for discounting costs of credit card processing for merchant participants is contemplated in accordance with various embodiments of the present disclosure. Generally, the method is directed to referring other merchants and allocating discounts for the referring merchant based upon the volume of usage thereby. Additional details of this method will be discussed more fully below. It is understood that the method may be implemented as one or more computer-executable instructions that can be stored on a data storage medium, though not necessarily limited thereto.

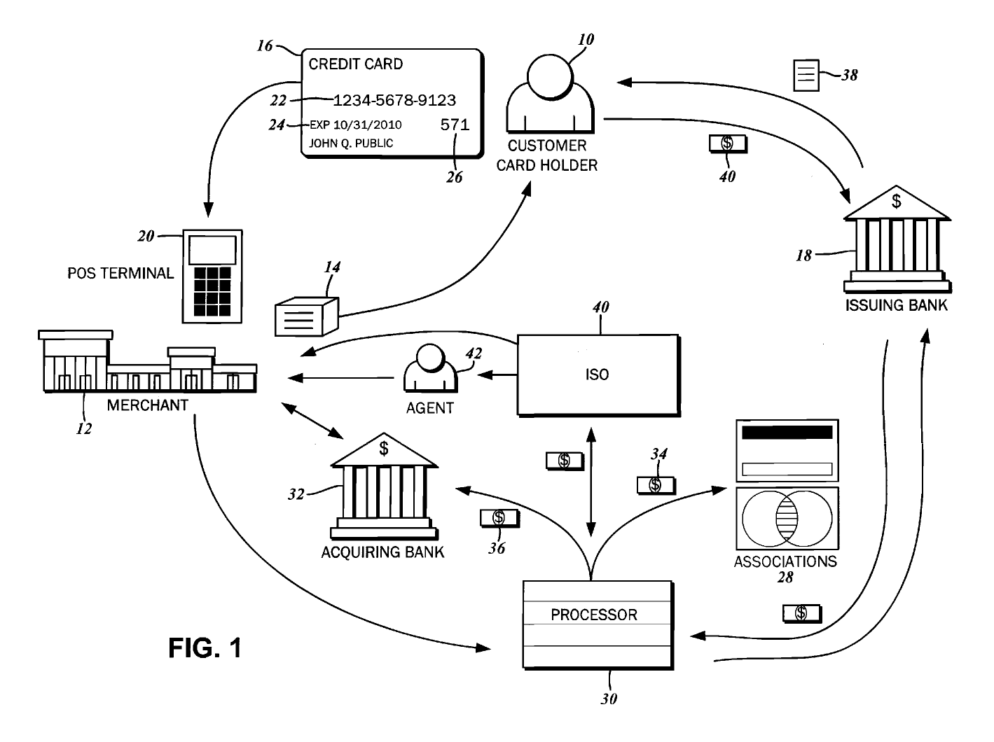

FIG. 1 illustrates pertinent relationships between various entities involved in a credit card transaction. At the outset, a customer 10 initiates a transaction with a merchant 12 to purchase goods or services 14. In exchange, the customer 10 provides the merchant 12 with a credit card 16, which is essentially credit extended to the customer 12 by an issuing bank 18, with whom the customer 12 has an agreement that any money paid to the merchants 12 through the credit card 16 will be repaid.

Credit cards are understood to refer to those deferred payment systems that permit the customer 10 to carry balances and repay the issuing bank 18 over time, subject to additional interest and possible fees. As utilized herein, however, credit cards may also refer to charge cards where the account balance is repaid in full on a monthly or other periodic basis, or debit cards where a checking account is immediately deducted. Each of these types of payment systems involve additional transaction costs that may be paid by either partially or fully by the merchant 12. The presently disclosed method for discounting such costs is intended to be applicable to those payment systems, as well as any others not specifically mentioned that involve such transaction costs. Along these lines, the following exemplary transaction will be described in relation to credit cards. While most other deferred payment systems operate similarly, to the extent that there are any differences, those having ordinary skill in the art will recognize and substitute for such alternatives.

Upon presenting the credit card 16 to the merchant 12, identification and authentication data associated therewith is entered into a point of sale (POS) terminal 20. Specifically, this includes an account number 22, a card expiration date 24, and a security identifier 26. This data is typically imprinted on the face of the credit card 16, as well as encoded in a magnetic stripe disposed on the reverse side. By swiping the magnetic stripe through a corresponding reader on the POS terminal 20, the data may be read and entered without further user intervention. If the magnetic stripe is unreadable, the data may be entered manually through a keypad. Along with the identification and authentication data, the amount to deduct from the account associated with the credit card 16 and transfer to the merchant 12 is entered. Generally, this is understood to constitute a conventional credit card transaction—the amount to charge, and the account identifier. An immediate approval is sought via an exchange with a credit card association 28 which include the aforementioned VISA®, MASTERCARD®, DISCOVER®, in order to confirm to the merchant 12 that the account associated with the credit card 16 has sufficient funds to cover the amount of the requested transaction. This may be completed via a transaction network to which the POS terminal 20 may be connected. The transaction network is understood to be set up and managed by the credit card association 28.

At predefined intervals, each of the accumulated transactions, which is also referred to as “batch,” from the merchant 12 are transferred to a processor 30, which processes the transactions to transfer funds to the merchant's account with an acquiring bank 30 in the amount specified. In completing the processing, the merchant 12 is charged an interchange fee 34 payable to the credit card association 28, as well as processing fees 36 from the processor 30, which may be deducted from the amount transferred to the merchant's account with the acquiring bank 32 or deducted on a periodic basis.

At or around the time of transferring the funds to the merchant's account with the acquiring bank 32, the processor 30 queries the issuing bank 18 to request a transfer from the account associated with the particular credit card 16. The issuing bank 18 maintains a record of all transactions made through the credit card 16, and sends a bill 38 to the customer on a periodic basis, which is typically monthly. Shortly upon receipt of the bill 38, the customer 10 is to submit a payment 40 to reimburse the issuing bank 18 as per the credit card agreement.

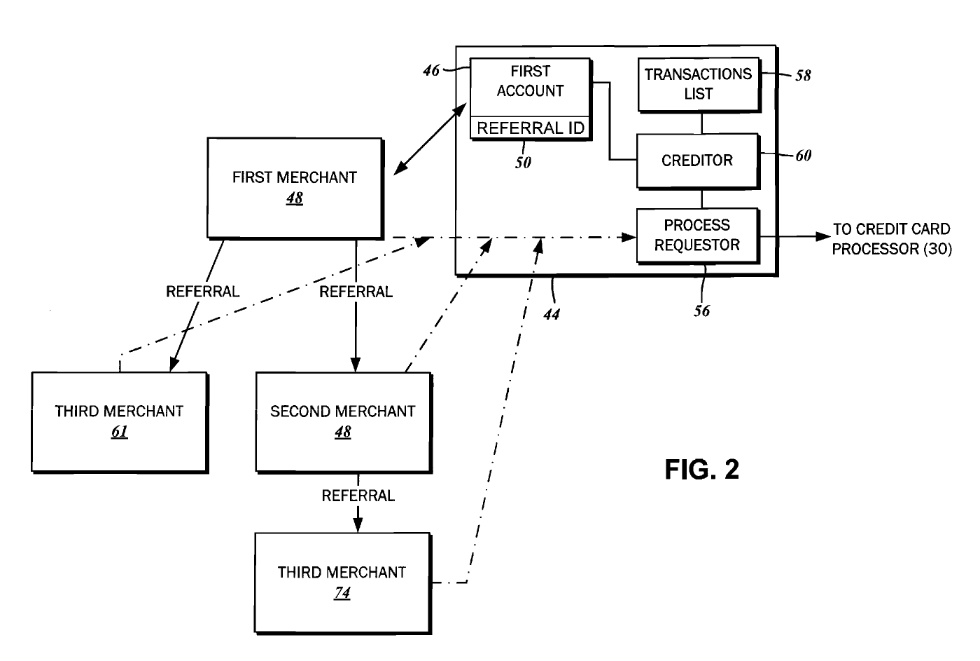

Presently, there are a number of credit card processors 30 in the market, with which merchants can process customer credit cards 16. These include Chase and First Data, among others. It is possible for merchants 12 to purchase the credit card processing services directly from the processor 30 at retail price. However, there are independent sales organizations (ISOs) 40 that resell the services to merchants 12 directly, or through agents 42. The processing services are offered to the ISOs 40 at a wholesale price, and then sold to the merchants 12 with varying markups. As utilized herein, the per-transaction markup added by the ISO 40 is also referred to as a cost differential, that is, on each transaction, the price that the ISO 40 pays to the processor 30 is different (lower) than the price that the merchant 12 pays to the ISO 40 for that same transaction. The cost differentials are understood to compensate the ISO 40 for performing business functions such as advertisement, management, and customer services for specific markets and regions that the processor 30 generally does not perform, or performs on a limited scale. In accordance with various embodiments of the present disclosure, such cost differentials serve as the basis for a method of issuing credits for costs of credit card processing to merchant participants. As shown in the block diagram of FIG. 2, a referral-based allocation of such cost differentials may be implemented as a program 44 managed by an entity such as the ISO 40 that are involved with both the merchants 12 and the processor 30.

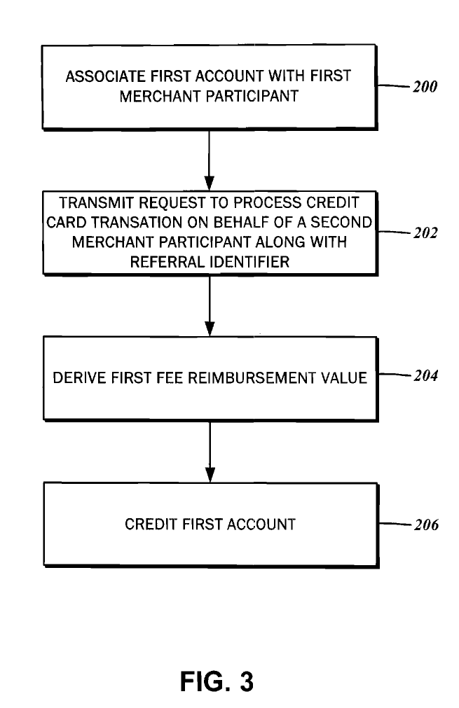

With additional reference to the flowchart of FIG. 3, the method begins with a step 200 of associating a first account 46 with a first one of the merchant participants 48. As utilized herein, the term merchant participant is utilized for purposes of convenience only, and not of limitation; it is expressly contemplated that merchant participants can also be reseller agents who do not independently utilized credit card processing services. A unique referral identifier 50 is also assigned to the first account 46. The referral identifier 50 may be distributed to a second one of the merchant participants 52, among others for various uses as will be described below. After becoming established in the program 44, the first one of the merchant participants 48, also referenced as a referring partner, may begin soliciting other merchants to utilize the credit card processing services offered by the ISO 40 that runs the program 44. As part of the account establishment process, the first one of the merchant participants 52 may be charged a membership fee that can be billed periodically, whether yearly, monthly, or another time span. The second one of the merchant participants 52 need not also become a referring partner, however, if desired.

The unique referral identifier 50 may be distributed to the second one of the merchant participants 52 in a variety of different ways. As will be described in further detail below, one contemplated embodiment of the present disclosure is implemented as a web-based application, so parameters to various functions may be specified as uniform resource identifiers (URIs). Accordingly, the function of associating new participant merchants with the first account 46, which may receive the referral identifier 50 as a parameter, may be specified through such a URI with the referral identifier 50 embedded therein. In one embodiment, the referral identifier 50 is transmitted to the second one of the merchant participants 52 in an e-mail message that includes the aforementioned URI. Once the included link is selected, the second one of the merchant participants 52 may be directed to a video explaining the program 44, and additionally research the same prior to committing. Although one way of distributing the referral identifier 50 has been disclosed, there are numerous other ways, including business cards and other forms of targeted advertising that may be utilized. The first one of the merchant participants 52 may receive notifications from the program 44 whenever new merchant participants submit inquiries under the referral identifier 50, including applications to participate and approval of such applications by the program 44.

The method then continues with a step 202 of transmitting to the credit card processor 30 a request 54 to process one or more credit card transactions on behalf of the second one of the merchant participants 52. Prior to this step, however, the first one of the merchant participants 52 refers the second one of the merchant participants to the program 44 for the purpose of utilizing its credit card processing services. The second one of the merchant participants 52 is given the referral identifier 50 that is particularly associated with the first one of the merchant participants 48. Each batch of transactions uploaded to a processing requestor 56 is accompanied by the referral identifier 50. A record of the second one of the merchant participants 52 including identity may be retained by the program 44 in connection with the first account 46 as being a participant that the first one of the merchant participants 48 referred to the program 44. As will be described in more detail below, the first one of the merchant participants 48 is given various incentives to continue referring additional merchants to the program 44. The program 44 relies at least in part on word-of-mouth advertising to gather additional customers or merchant participants, and therefore it is possible to reduce the number of or eliminate entirely the agents 42 who would otherwise be soliciting participants. Furthermore, advertising expenses may be reduced. The ISO 40 may realize additional profit because of such cost reduction measures, or savings may be passed on to the merchants 12. As noted above, however, the present disclosure contemplates the selective crediting of merchants 12 based upon the volume of transactions processed on behalf of referred merchants.

Once the process requestor 56 receives the batch from the second merchant 52, they are recorded in a transaction list 58 specific to the second merchant 52 and associated with the first merchant 52 as designated by the accompanying referral identifier 50. The process requestor 56 then forwards the batch to the processor 30 and continues the credit card payment issue in the same manner discussed above with respect to the merchant 12 directly uploading the batches to the processor 30.

Referring again to the flowchart of FIG. 3, the method continues with a step 204 of deriving a first fee reimbursement value from the credit card transactions processed on behalf of the second one of the merchant participants 52. Apart from the transaction list 58 and the process requestor 54, the program 44 may include an account creditor 60 that performs this step. The first fee reimbursement value may be calculated on a periodic basis after all of the credit card batches from the second one of the merchant participants 52 have been uploaded for that cycle. The periodic basis may be daily, weekly, monthly, or other convenient basis. As indicated above, each of the processed credit card transactions will have an associated cost differential. A first fraction of this cost differential is intended for compensation to the program 44, while another fraction may be a rebate, credit, or other compensation applied to the first one of the merchant participants in accordance with various embodiments of the present disclosure. In this regard, it is intended for the cost differential to be payable by the second one of the merchant participants as part of the processing fees included in each of the transactions.

Per conventional industry practice, the total feels payable by the second merchant participant 52 is approximately 4%, and includes the aforementioned processing fees and the interchange fees. From this 4%, the ISO 40 typically earns 10% to 25% as the cost differential, and a fraction of that is what is being credited to the first one of the merchant participants 48 that refers the second merchant participant 52 to the program 44. As will be appreciated, the specific way in which the first fee reimbursement value is derived, i.e., where fractions of the cost differential is the fee reimbursement value, is presented by way of example only and not of limitation. Any other suitable basis to determine the fee reimbursement value may be readily substituted, such as the volume or number of transactions processed. Indeed, several different types of rebate derivation methods may be utilized concurrently for different participating merchants depending upon the specific needs and incentives for the merchant participants.

The method continues with a step 206 of applying a credit to the first account 46 that is based upon the first fee reimbursement value derived in the step 204. The role of the first one of the merchant participants 48 is not limited to that of referring other merchant participants to the program 44, and transmits to the program 44 requests to process one more of its own credit card transactions that are to be forwarded to the processor 30. Again, each credit card transaction processed on behalf of the first merchant participant 38 also includes a cost differential payable thereby. In the first account 46, a record of each of the credit cards transactions is maintained, and an aggregate processing fee is charged to the first one of the merchant participants 48 in each billing cycle. Various embodiment of the present disclosure contemplate, however, that to the extent that the first account 46 is owed a reimbursement for the credit card processing activities of the second merchant participant 52, the derived first fee reimbursement value is subtracted from that aggregate processing fee otherwise payable by the first one of the merchant participants 48.

The first fee reimbursement value increases as the first one of the merchant participants 48 refers more merchants, or refers merchant participants with greater credit card transaction volumes. With an additional third one of the merchant participants 61 referred to the program 44, the credit card transaction processing fees collected by the processor 30 and the cost differentials payable to the ISO 40 correspondingly increase. As such, the amount that can be credited to the referring partner, i.e. the first one of the merchant participants 48, also increases. The steps 204 of deriving the fee reimbursement value and 206 of crediting the account for the referring partner continues so long as the referred merchant participants continue to process credit card transactions through the program 44.

It is conceivable that the first one of the merchant participants 48 refers so much business to the program 44, that the first fee reimbursement value exceeds that of the fees payable thereby for its own credit card transaction processing. If this occurs, the first account 46 may be credited with that differential for application to future billing cycles when the first fee reimbursement value may not be as high. Alternatively, or in conjunction with the processing fee reductions, other incentives such cash back, gift cards, consumer electronic devices, etc. may be offered to the first one of the merchant participant 48. It is envisioned that there are no limits imposed on the first fee reimbursement value, though in some circumstances it may be appropriate or desirable to do so.

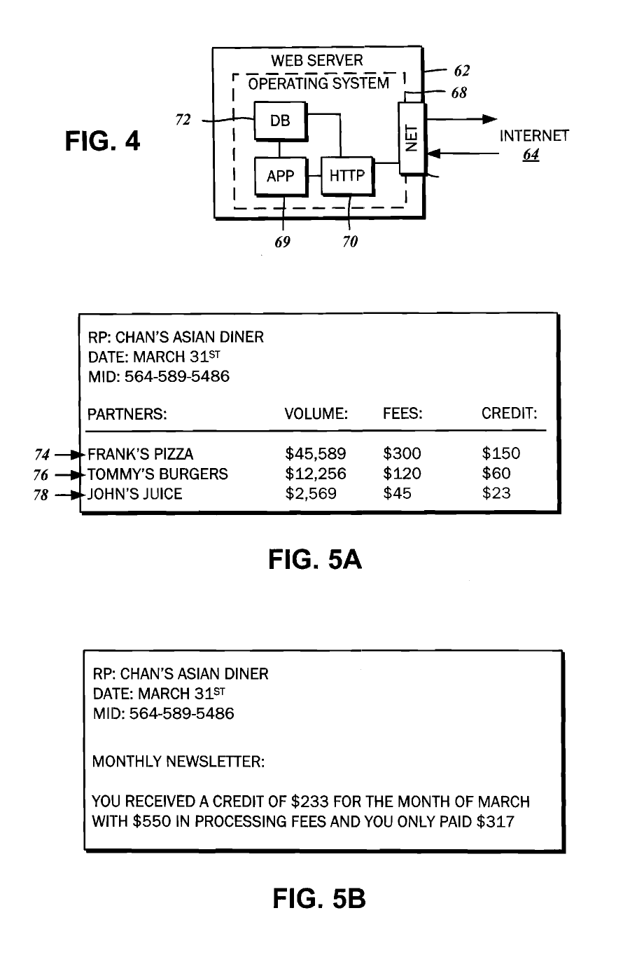

As shown in the block diagram of FIG. 4 and as briefly noted above, in one contemplated embodiment, the program 44 is administered over the web. With further reference to the block diagram of FIG. 4, the first account 46 may be established on an administrative application running on a web server 62 connected to the Internet 64, and the various functions of deriving fee reimbursements and applying credits may be provided by the same. Additionally, the forms in which account setup information is requested may likewise be generated by the web server 62.

The web server 62 is understood to have a network interface 66 that is linked to the Internet 64. In this context, the network interface 66 is representative of the physical device connecting the web server 62 to the Internet 64 such as an Ethernet network interface card, as well as the logical module or protocol stack performing various higher level communications tasks for Internet Protocol (IP) networking.

As is the case with most computer systems configured to serve web pages, a base operating system 68 may be running thereon. The operating system 68 may manage one or more server applications including a HyperText Transfer Protocol (HTTP) server 70 that receives requests (in the form of Uniform Resource Identifiers (URIs) for a specific HyperText Markup Language (HTML) document, and transmits that document back to the requestor. Additional data included in those pages, as well as the aforementioned account-related data, may be retrieved from a separate database 72. The functionality noted above, including account setup, derivation fee reimbursements, and so forth, may be specifically implemented as a series of instructions executable by an application server 69 that generates outputs produced as web pages by the HTTP server 70. Although the specific implementation of the program 44 on the web server 62 is described herein, it is not intended to be limiting, and other implementations may be substituted.

Another aspect of the disclosure includes generating a statement at the conclusion of a billing cycle. The statement may include some of the pertinent data discussed above. FIG. 5A, which is for a referring partner (first one of the merchant participants 48) named “Chan's Asian Diner,” and this statement will be utilized to present an example of how the program operates. Based upon the statement, it shows that the first one of the merchant participants 48 has referred three merchant participants including one named “Frank's Pizza,” another named “Tommy's Burgers” and “John's Juice.” As shown in a first statement row 74, the merchant participant “Frank's Pizza” had a transaction volume of $45,859 during the billing cycle, which generated $300 in fees payable to the ISO 40/program 44. Based upon these transactions, a fee reimbursement for this referred merchant participant was derived as a $150 credit. Furthermore, as shown in the second statement row 76, the merchant named “Tommy's Burgers” had a transaction volume of $12,256 during the billing cycle, which generated $120 in fees payable to the ISO 40/program 44. A fee reimbursement for this referred merchant participant was derived as a $60 credit. A third statement row 78 is for the merchant named “John's Juice,” which had a transaction volume of $2,569 that generated $45 in fees. A fee reimbursement for this referred merchant was derived as a $23 credit. As shown herein, the fees listed in the statement refer only to processing fees, which are understood to be separate from the interchange fees noted above. In some cases, depending upon the privacy desires of the referred merchants, some or all of this information may be omitted from the statements, and only the amount credited to the first one of the merchant participants 48 may be presented.

FIG. 5B illustrates an example second type of statement which may also be referred to as a newsletter, which shows the amount credited to the referring partner, the processing fees paid by the referring partner for its own credit card transactions, and the total amount paid or payable after the earned credit is applied. In this example, the total sum of credits as indicated on the statement shown in FIG. 5A, or $233, is applied to the referring partner's existing balance for processing fees of $550, leaving a final balance of $317. Additional information such as the year-to-date credits received, the number of additional referrals necessary to begin participating in various stages of the program 44, and the like may also be included in this second type of statement.

As best illustrated in FIG. 2, one embodiment of the present disclosure contemplates a single level referral program, where the first one of the merchant participants 48 refers the second one of the merchant participants 52 and the third one of the merchant participants 61 to the program 44. The first fee reimbursement value credited to the first account is based upon the credit card transaction requests for those second and third ones of the merchant participants 52, 61; to the extent that those referred merchants further refer others such as a fourth one of the merchant participants 80, the credit card transaction requests from those second level merchants will not be accounted for in the first fee reimbursement value.

In another embodiment, however, two or multilevel referral program may be implemented. Again, the first one of the merchant participants 48 refers the second one of the merchant participants 52. A fourth one of the merchant participants 80 is referred, in turn, by the second one the merchant participants 52. In this contemplated embodiment, the first account 46 is at least partially credited with a fee reimbursement value attributable to the credit card transactions processed on behalf of the fourth one of the merchant participants 80. Additionally, it is also contemplated that an account associated with the second one of the merchant participants 80 (which is subsequently established with the program 44) is credited with another fraction of the cost differential paid by the fourth one of the merchant participants 80. This may be the same as that credited to the first one of the merchant participants 52, less than that credited to the first one of the merchant participants 52, or greater than that credited to the first one of the merchant participants 52, depending upon the particular needs and incentives desired in the program 44. Along these lines, it is intended that referral program not be limited to two levels as described above, and any suitable number of referral levels may be established, with each level taking a different fraction of the cost differential paid.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method for issuing credits for costs of credit card processing for merchant participants, comprising:
associating a first account with a first one of the merchant participants, a unique referral identifier being assigned to the first account and distributable to a second one of the merchant participants;
transmitting to a credit card processor a request to process one or more credit card transactions on behalf of the second one of the merchant participants, each of the credit card transactions having a cost differential associated therewith and including the unique referral identifier assigned to the first account;
deriving a first fee reimbursement value from the credit card transactions processed on behalf of the second one of the merchant participants within a cycle; and
crediting the first account based upon the first fee reimbursement value;
wherein the cost differentials are payable by the second one of the merchant participants.

2. The method of claim 1, wherein the cost differential of a given one of the credit card transactions is the difference between the amount the second one of the merchants is charged and the amount charged by the credit card processor for the given one of the credit card transactions.

3. The method of claim 1, wherein the first fee reimbursement value is based upon the number of transactions processed on behalf of the second one of the merchant participants.

4. The method of claim 1, wherein the first fee reimbursement value is based upon the total of the cost differentials of one or more of the transactions processed on behalf of the second one of the merchant participants.

5. The method of claim 1, wherein the credit card transactions each include an interchange fee payable by the second one of the merchant participants.

6. The method of claim 1, further comprising:
transmitting to the credit card processor a request to process one or more credit card transactions on behalf of the first one of the merchant participants, each of the credit card transactions having a cost differential associated therewith.

7. The method of claim 6, wherein the credit card transactions each include an interchange fee payable by the first one of the merchant participants.

8. The method of claim 6, wherein crediting the first account includes subtracting the first fee reimbursement value from a total of the cost differentials of all of the credit card transactions processed on behalf of the first of the merchant participants within the cycle.

9. The method of claim 6, further comprising:
generating a statement including a total of the cost differentials of the credit card transactions processed on behalf of the first of the merchant participants within the cycle, and the first fee reimbursement value.

10. The method of claim 1, further comprising:
transmitting a request to process one or more credit card transactions on behalf of a third one of the merchant participants, each of the credit card transactions having a cost differential associated therewith and including the unique referral identifier assigned to the first account;
deriving a second fee reimbursement value from the credit card transaction processed on behalf of the third one of the merchant participants within the cycle; and

11. The method of claim 10, further comprising:
crediting the first account based upon a sum of the second fee reimbursement value and the first fee reimbursement value.

12. The method of claim 10, further comprising:
crediting the second one of the merchant participants based upon the second fee reimbursement value.

13. The method of claim 10, wherein the second fee reimbursement value is based upon the number of transactions processed on behalf of the third one of the merchant participants.

14. The method of claim 10, wherein the second fee reimbursement value is based upon the total of the cost differentials of one or more of the transactions processed on behalf of the third one of the merchant participants.

15. The method of claim 1, further comprising:
linking the second one of the merchant participants as a referral from the first one of the merchant participants in the first account.

16. The method of claim 15, further comprising:
generating a notification to the first one the merchant participants in response to linking the second one of the merchant participants as a referral.

17. An article of manufacture comprising a program storage medium readable by a computer, the medium tangibly embodying one or more programs of instructions executable by the computer to perform a method for discounting costs of credit card processing for merchant participants, the method comprising:
associating a first account with a first one of the merchant participants, a unique referral identifier being assigned to the first account and distributable to a second one of the merchant participants;
transmitting to a credit card processor a request to process one or more credit card transactions on behalf of the second one of the merchant participants, each of the credit card transactions having a cost differential associated therewith and including the unique referral identifier assigned to the first account;
deriving a first fee reimbursement value from the credit card transactions processed on behalf of the second one of the merchant participants within a cycle; and
crediting the first account based upon the first fee reimbursement value;
wherein the cost differentials are payable by the second one of the merchant participants.
